(19) United States
(12) Patent Application Publication
(10) Pub. No.: US 2026/0171841 A1
(43) Pub. Date: Jun. 18, 2026

(54) ELECTRIC METER COMPRISING A POWER RELAY AND METHOD FOR MONITORING THE POWER RELAY OF AN ELECTRIC METER

(71) Applicant: SAGEMCOM ENERGY & TELECOM SAS, BOIS-COLOMBES (FR)

(72) Inventors: Christophe GRINCOURT, BOIS-COLOMBES (FR); Marc JEANROT, BOIS-COLOMBES (FR)

(21) Appl. No.: 19/425,996

(22) Filed: Dec. 18, 2025

(30) Foreign Application Priority Data
Dec. 18, 2024 (FR) 2414479

(51) Int. Cl. H02J 13/12; G01K 7/18; H02J 13/13; H02J 13/34

(52) U.S. Cl. CPC H02J 13/12; G01K 7/18; H02J 13/1321; H02J 13/34

(57) ABSTRACT

In an electrical device connected between an electrical network and an electrical installation, for example an electricity meter, the monitoring method disclosed allows the value of the contact resistance of a power relay of the device to be estimated in real time. The method raises an alarm when resistance rises sharply. This allows real-time detection of abnormal heating of the power relay, which could, for example, lead to a fire. This also allows the electricity meter of an installation to be exonerated in the event of a fire.

### CROSS-REFERENCE TO RELATED APPLICATIONS

The present application claims priority to French Application No. 2414479 filed with the Intellectual Property Office of France on Dec. 18, 2024, which is incorporated herein by reference in its entirety for all purposes.

### TECHNICAL FIELD

The various embodiments described in the present disclosure relate to an electricity meter comprising a power relay intended to be connected upstream to an electrical network and downstream to an installation. They also relate to a method for monitoring the power relay of such an electricity meter.

### TECHNICAL BACKGROUND

An electricity meter typically includes a power relay that can be closed or opened to manage the connection between an electrical network and an electrical installation. This power relay may become hot, for example in the event of a high current. Extreme temperature in the power relay can cause the meter to catch fire.

In the state of the art it is known to monitor the temperature in the meter and generate alerts when it exceeds a certain threshold. These methods depend on the external temperature and are therefore imprecise.

There is a need for a monitoring method that allows an abnormal temperature in the power relay to be detected with greater accuracy.

### SUMMARY

The independent claims define several aspects of the present disclosure. Further aspects or embodiments are defined in the dependent claims.

A first aspect of the present disclosure relates to a method for monitoring an electrical device intended to be mounted between an electrical network and an electrical installation. The electrical network delivers an electrical signal to one or more phases.

The electrical device disclosed herein comprises at least:
for each phase, a current sensor mounted in series with a power relay and intended to measure a current flowing in the power relay when it is closed, the current sensor being intended to be connected to the electrical network at an upstream point and the power relay being intended to be connected to the installation at a downstream point,
for each phase, a first voltage sensor mounted at the upstream point to measure an upstream voltage,
for each phase, a second voltage sensor mounted at the downstream point to measure a downstream voltage,
at least one analog-to-digital converter, configured to obtain, for each phase, at a plurality of measurement times over one or more measurement periods, samples of the upstream voltage, the downstream voltage and the current, and
a transmission modem.

The device monitoring method comprises at least the following steps:
determining, for each phase, from the samples obtained, magnitudes the ratio of which is representative of a resistance value of the power relay for the measurement period,
generating an alert based on the ratio obtained, and
transmitting an alert via the transmission modem.

The monitoring method estimates the resistance value of the contact of the power relay in real time, in order to detect abnormal heating of the power relay, which could lead to the generation of a flame that could cause a fire. It allows an alarm to be raised before the risk of fire becomes too critical. It can also be used to exonerate the electricity meter of an installation in the event of a fire (if the estimated resistance value of the power relay is low, this proves that the meter is not the cause of the fire).

An advantage of this monitoring method is that it does not require measuring temperature. The results obtained are more precise than those obtained with temperature measurements and are not dependent on the outside temperature. Another advantage is that the method can be implemented in any electrical device or electricity meter since it uses measurements and calculations that can be carried out using standard electronics and software. The method can be implemented by computer. Meters that are already installed in the network can be upgraded remotely to include a software version suitable for implementing the method.

In a first embodiment of the monitoring method, the samples of upstream voltage, downstream voltage and current are obtained from the same analog-to-digital converter. The method then comprises:
determining, for each measurement time of each measurement period, a difference between a first function of the upstream voltage samples and a second function of the downstream voltage samples,
integrating the differences determined over each measurement period, to obtain a first magnitude representative of a voltage at the terminals of the power relay for each measurement period,
integrating a third function of the current samples over each measurement period, to obtain a second magnitude representative of the current flowing in the power relay for each measurement period,
calculating a ratio between the first and second magnitudes, or between an average of the first magnitudes and an average of the second magnitudes, to obtain the resistance value of the power relay for the measurement period(s).

This embodiment is particularly accurate, but requires the samples to be obtained by the same analog-to-digital converter, since the samples must be synchronous in order to calculate the said difference.

In certain cases, especially for certain meters in the existing inventory, the samples are obtained from several analog-to-digital converters, typically a first converter (for example with 24-bit resolution) to obtain the upstream voltage and current samples, and a second converter (for example with 12-bit resolution) for the downstream voltage samples. In this case, according to a second embodiment, the monitoring method comprises for each phase:
integrating a first function of the upstream voltage samples over each measurement period to obtain a value representative of the upstream voltage,
integrating a second function of the downstream voltage samples over each measurement period to obtain a value representative of the downstream voltage,
determining a difference between the value representing the upstream voltage and the value representing the downstream voltage, to obtain a first magnitude representing a voltage at the terminals of the power relay for each measurement period,
integrating a third function of the current samples over each measurement period, to obtain a second magnitude representative of the current flowing in the power relay for each measurement period,
calculating a ratio between the first and second magnitudes, or between an average of the first magnitudes and an average of the second magnitudes, to obtain the resistance value of the power relay for the measurement period(s).

Advantageously, the first, second and third function respectively comprise multiplying the samples of upstream voltage, downstream voltage and current by a gain of upstream voltage, downstream voltage and current respectively.

The gains are determined during a calibration phase, in the factory, and are used to offset the errors introduced by the imprecision of the values of the components used in the sensors.

The results obtained in the first and second embodiments can be improved by implementing one or more of the steps listed below:
disregarding the samples associated with a current measurement prone to noise.
considering several measurement periods, the average of the first magnitudes and the average of the second magnitudes being obtained by applying selective digital filtering of rectangular impulse response and sin(x)/x frequency response.
using a first, second, and third function that respectively comprise Butterworth filtering of said samples, at least of the third order, and presenting a cutoff frequency, for example, 3 to 25 times greater than that of the electrical signal.

According to one variant, when the measurement times of the samples are synchronized with the electrical signal, the integrations are replaced by selections of a maximum value taken over the measurement period in the first and second embodiments of the monitoring method.

Another aspect of the present disclosure relates to a device intended to be mounted between an electrical network and an installation, and which comprises a processor assembly configured to implement the monitoring method described above, in its various combinations.

Another aspect relates to a computer program product comprising instructions which when executed by at least one processor cause the monitoring method disclosed hereinbefore to be implemented.

Another aspect relates to a non-transitory computer-readable storage medium comprising instructions which when executed by a processor cause the monitoring method described hereinbefore to be implemented.

### BRIEF DESCRIPTION OF THE FIGURES

The embodiments will be better understood in light of the following detailed description and the accompanying drawings, which are given for purposes of illustration only and do not limit the present disclosure.

FIG. 1 is a block diagram of a first example of an electrical device according to the present disclosure.

FIG. 2 is a flowchart of a monitoring method intended to be implemented in a device of the type described in FIG. 1.

FIG. 3 is a block diagram of a second example of an electrical device according to the present disclosure.

FIG. 4 is a flowchart of a monitoring method intended to be implemented in a device of the type described in FIG. 3.

### DETAILED DESCRIPTION

Various embodiments will now be described in more detail, non-limitingly, with reference to the drawings accompanying the present disclosure and showing certain exemplary embodiments.

Hereinafter, to simplify the presentation, an electrical device and a monitoring method suitable for the case of a single-phase network is disclosed. This is not exhaustive. When the network is multi-phase, that is, when it delivers an electrical signal with multiple phases, the components and operations disclosed are replicated for each phase of the network.

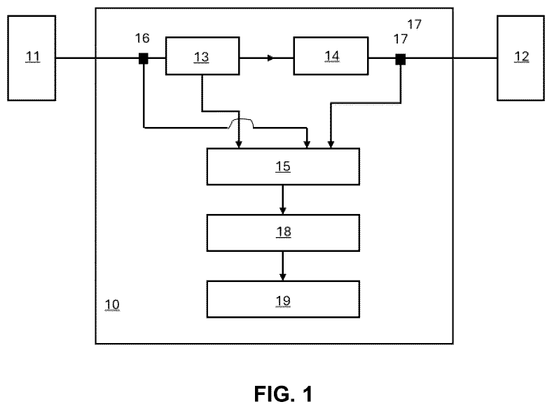

FIG. 1 discloses an electrical device 10 mounted between a single-phase electrical network 11 and an electrical installation 12. The device 10 comprises a current sensor 13, connected in series with a power relay 14. The power relay 14 is connected to the electrical installation and allows the installation 12 to be connected/disconnected from the electrical network 11. Current from the electrical network 11 flows through the sensor 13 and then, when it is closed, through the power relay 14. For example, the current sensor 13 consists of a shunt resistor or a transformer. The current I measured by the current sensor 13 is supplied to an analog-to-digital converter 15. The analog-to-digital converter 15 also receives the voltage V0 measured by a voltage sensor 16 upstream of the current sensor 13, and the voltage V1 measured by a voltage sensor 17 downstream of the power relay 14. For example, the voltage sensors consist of resistive dividers.

The analog-to-digital converter 15 is configured to obtain a plurality of measurement times tk (where k is a natural number) over one or more measurement periods, samples V0(k), V1(k) and I(k) of the upstream voltage, the downstream voltage and the current. Typically, the voltage that is to be measured at the terminals of power relay 14 is a few hundred mV, whereas the voltage at the upstream and downstream points is several hundred volts. For example, a 24-bit sigma-delta converter is used, the resolution of which is sufficient to obtain accurate measurements.

These samples are supplied to a processor assembly 18 of the device 10 which is configured to determine, from the samples received, magnitudes the ratio of which is representative of a power relay resistance value, and to generate an alert based on the ratio obtained.

The alert is transmitted, for example to the operator of the electricity grid 11, via a modem 19 of the device 10.

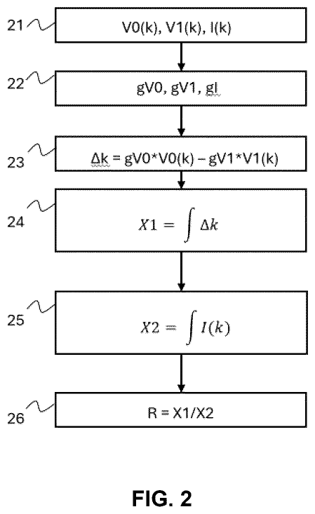

In the example shown in FIG. 1, the samples of upstream voltage, downstream voltage and current are obtained from the same analog-to-digital converter 15. They are therefore synchronous. In this case, advantageously, the processor assembly 18 is configured to execute the process described in FIG. 2.

In 21, the samples of upstream voltage V0(k), downstream voltage V1(k) and current I(k) are supplied by the analog-to-digital converter 15 to the processor assembly 18. In 22, a gain g_{Vo}, g_{V1}, and g_{I} respectively is applied to the samples V0(k), V1(k) et I(k). The value of these gains is determined during a calibration phase to offset the error introduced by the uncertainty regarding the sensor components (error in the resistances/number of transformer turns). The samples obtained are called calibrated samples. In 23, the processor assembly determines, for each measurement time tk of each measurement period, a difference Ok between the calibrated upstream voltage samples g_{V0}*V0(k) and the calibrated downstream voltage samples gV1*V1(k). This difference corresponds to the voltage at the contact terminals of the power relay 14, because the impedance of the copper arms is very low and therefore negligible compared to the resistance of the contact. For devices in which current measurement is performed by a shunt resistor, the difference in potential corresponds to the voltage at the contact terminals of the power relay 14 and of the shunt resistor.

In 24, the processor assembly 18 integrates the differences Ak over each measurement period to obtain the effective value of the voltage difference (Root Mean Square, or RMS value). This RMS value constitutes a first magnitude X1 representative of the voltage at the terminals of the power relay 14 for each measurement period. In 25, it integrates the calibrated current samples I(k) over each measurement period, to obtain an RMS value of the current. The RMS value of the current constitutes a second magnitude X2 representative of the current flowing in the power relay for each measurement period. In 26, the processor assembly calculates the ratio between the first and second magnitude, or between an average of the first magnitudes and an average of the second magnitudes, to obtain the resistance value of the power relay for the measurement period(s).

The duration of the integration may vary. For example, the resistance value of the power relay can be determined for each period of the electrical signal (that is, for a 50 Hz electrical signal, every 20 ms). It is also possible to integrate over longer periods to obtain magnitudes that are more averaged and, therefore, more accurate. Advantageously, integration is over one or more whole periods of the electrical signal.

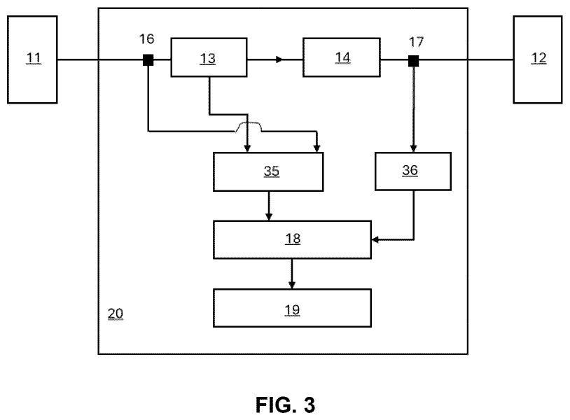

FIG. 3 discloses another variant of the electrical device mounted between a single-phase electrical network 11 and an electrical installation 12. The device 30 differs from the device 10 in that it comprises two analog-to-digital converters 35 and 36. The current I measured by the current sensor 13 is supplied to the first analog-to-digital converter 35. The analog-to-digital converter 35 also receives the voltage V0 measured by a voltage sensor 16 upstream of the current sensor 13. It supplies the processor assembly 18 with the samples V0(k) and I(k). The second analog-to-digital converter 36 receives the voltage V1 measured by a voltage sensor 17 downstream of the power relay 14. It supplies the processor assembly 18 with the samples V1(k).

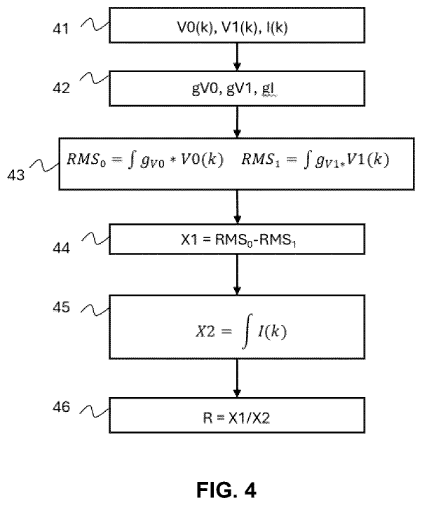

In the example shown in FIG. 3, the samples of upstream voltage, downstream voltage and current are obtained from two different analog-to-digital converters, and are therefore not synchronous. In this case, advantageously, the processor assembly 18 is configured to execute the process described in FIG. 4. This configuration can be found, for example, in older electricity meters already installed in the network. The software version of these meters can be updated to implement the algorithm disclosed with reference to FIG. 4.

In 41, the samples of upstream voltage V0(k) and of current I(k) are supplied by the analog-to-digital converter 35 to the processor assembly 18. And the samples of downstream voltage V1(k) are supplied by the analog-to-digital converter 36 to the processor assembly 18. In 42, a gain gVo, gV1, and gI respectively is applied to the samples V0(k), V1(k) et I(k). The value of these gains is determined during a calibration phase to offset the error introduced by the uncertainty regarding the sensor components. The samples obtained are called calibrated samples. In 43, the processor assembly integrates the calibrated upstream voltage samples gV0*V0(k) over the measurement period to obtain an RMS value for the upstream voltage, labeled RMS₀, and the calibrated downstream voltage samples gV1*V1(k) over the measurement period to obtain an RMS value for the downstream voltage, labeled RMS₁. In 44, a difference between the RMS value of upstream voltage and the RMS value of downstream voltage is calculated. This difference constitutes a first magnitude X1 representative of the voltage at the terminals of the power relay for each measurement period. In 45, the processor assembly constitutes integrates the calibrated current samples I(k) over each measurement period to obtain an RMS value of the current. The RMS value of the current constitutes a second magnitude X2 representative of the current flowing in the power relay for each measurement period. In 46, the processor assembly calculates the ratio between the first and second magnitude, or between an average of the first magnitudes and an average of the second magnitudes, to obtain the resistance value R of the power relay for the measurement period(s).

Advantageously, the samples corresponding to a low current measurement are disregarded because they are prone to noise. For example, if the measured current is below a threshold, the associated measurements are not taken into account in the calculations. Typically, measurements above 10 A can be used.

In the example shown in FIGS. 2 and 4, the first, second and third functions applied in 22 and 42 to the samples of upstream voltage, downstream voltage and current are multiplicative functions that multiply the samples by predetermined calibration gains. In one embodiment, in addition to applying a calibration gain, these functions comprise Butterworth filtering of the calibrated samples, at least of the third order, and presenting a cut-off frequency 3 to 25 times greater than the signal.

When the measurement times of the samples are synchronized with the electrical signal, the integration operation can be replaced by selecting the maximum sample value over the measurement period. For example, the maximum values obtained can then be averaged over several measurement periods. This can be achieved by selective digital filtering with rectangular impulse response and sin(x)/x frequency response.

Note that the second converter 36 can be integrated into the processor assembly 18. The integrated converters are generally less precise (typically 12-bit instead of 24-bit for the converters 15 or 35). A 12-bit resolution is generally sufficient to measure the voltage at the downstream point.

It is also possible to use the embodiment shown in FIG. 4 with a device according to FIG. 1 (a single converter 15). However, the results are less precise.

The person skilled in the art will understand that all the block diagrams presented here represent conceptual views, given by way of example, of circuits incorporating the principles of the disclosure. The specific structural and functional details disclosed herein are non-limiting examples. The subject matter of the disclosure may be embodied in many different forms and should not be construed as being limited solely to the embodiments presented herein as illustrative examples.

1. An electrical device configured to be mounted between an electrical network and an electrical installation, the electrical network delivering an electrical signal to one or more phases, the device comprising at least:
for each phase, a current sensor mounted in series with a power relay and intended to measure a current flowing in the power relay when it is closed, the current sensor being intended to be connected to the electrical network at an upstream point and the power relay being intended to be connected to the installation at a downstream point,
for each phase, a first voltage sensor mounted at the upstream point to measure an upstream voltage,
for each phase, a second voltage sensor mounted at the downstream point to measure a downstream voltage,
at least one analog-to-digital converter, configured to obtain, for each phase, at a plurality of measurement times over one or more measurement periods, samples of the upstream voltage, the downstream voltage and the current,
a processor assembly configured to determine, for each phase, from the samples obtained, magnitudes the ratio of which is representative of a resistance value of the power relay, and to generate an alert based on the ratio obtained, and
a modem to transmit the alert.

2. The electrical device according to claim 1, wherein the samples of upstream voltage, downstream voltage and current are obtained from the same analog-to-digital converter, and the processor assembly is configured, for each phase, to:
determine, for each measurement time of each measurement period, a difference between a first function of the upstream voltage samples and a second function of the downstream voltage samples,
integrate the differences determined over each measurement period, to obtain a first magnitude representative of a voltage at the terminals of the power relay for each measurement period,
integrate a third function of the current samples over each measurement period, to obtain a second magnitude representative of the current flowing in the power relay for each measurement period, and
calculate the ratio between the first and second magnitudes, or between an average of the first magnitudes and an average of the second magnitudes, to obtain the resistance value of the power relay for the measurement period(s).

3. The electrical device according to claim 1, wherein the samples are obtained from a plurality of analog-to-digital converters and the processor assembly is configured, for each phase, to:
integrate a first function of the upstream voltage samples over each measurement period to obtain a value representative of the upstream voltage,
integrate a second function of the downstream voltage samples over each measurement period to obtain a value representative of the downstream voltage,
determine a difference between the value representing the upstream voltage and the value representing the downstream voltage, to obtain a first magnitude representing a voltage at the terminals of the power relay for each measurement period,
integrate a third function of the current samples over each measurement period, to obtain a second magnitude representative of the current flowing in the power relay for each measurement period, and
calculate the ratio between the first and second magnitudes, or between an average of the first magnitudes and an average of the second magnitudes, to obtain the resistance value of the power relay for the measurement period(s).

4. The device according to claim 1, wherein the first, second and third functions respectively comprise multiplying the samples of upstream voltage, downstream voltage and current by a gain of upstream voltage, downstream voltage and current, respectively.

5. The electrical device according to claim 2, wherein the average of the first magnitudes and the average of the second magnitudes are obtained by applying selective digital filtering of rectangular impulse response and sin(x)/x frequency response.

6. The device according to claim 2, wherein the first, second, and third function respectively comprise Butterworth filtering of said samples, at least of the third order, and presenting a cutoff frequency 3 to 25 times greater than that of the signal.

7. The device according to claim 1, wherein a measurement period includes one or more whole signal periods.

8. The device according to claim 1, wherein when the measurement times of the samples are synchronized with the electrical signal, instead of integrating, the processor assembly is configured to select a maximum value taken over the measurement period.

9. The device according to claim 1, wherein the processor assembly is configured to disregard the samples associated with a current measurement prone to noise.

10. A method for monitoring an electrical device configured to be mounted between an electrical network and an installation, the electrical network delivering an electrical signal to one or more phases, the device comprising at least:
for each phase, a current sensor mounted in series with a power relay and intended to measure a current flowing in the power relay when it is closed, the current sensor being intended to be connected to the electrical network at an upstream point and the power relay being intended to be connected to the installation at a downstream point,
for each phase, a first voltage sensor mounted at the upstream point to measure an upstream voltage,
for each phase, a second voltage sensor mounted at the downstream point to measure a downstream voltage,
at least one analog-to-digital converter, configured to obtain, for each phase, at a plurality of measurement times over one or more measurement periods, samples of the upstream voltage, the downstream voltage and the current,
a transmission modem,
the monitoring method comprising:
determining, for each phase, from the samples obtained, magnitudes the ratio of which is representative of a resistance value of the power relay for the measurement period,
generating an alert based on the ratio obtained, and
transmitting an alert via the transmission modem.

11. The monitoring method according to claim 10, wherein the samples of upstream voltage, downstream voltage and current are obtained from the same analog-to-digital converter, and the method comprising:
determining, for each measurement time of each measurement period, a difference between a first function of the upstream voltage samples and a second function of the downstream voltage samples,
integrating the differences determined over each measurement period, to obtain a first magnitude representative of a voltage at the terminals of the power relay for each measurement period,
integrating a third function of the current samples over each measurement period, to obtain a second magnitude representative of the current flowing in the power relay for each measurement period, and
calculating a ratio between the first and second magnitudes, or between an average of the first magnitudes and an average of the second magnitudes, to obtain the resistance value of the power relay for the measurement period(s).

12. The monitoring method according to claim 10, wherein the samples are obtained from a plurality of analog-to-digital converters and the method comprising, for each phase:
integrating a first function of the upstream voltage samples over each measurement period to obtain a value representative of the upstream voltage,
integrating a second function of the downstream voltage samples over each measurement period to obtain a value representative of the downstream voltage,
determining a difference between the value representing the upstream voltage and the value representing the downstream voltage, to obtain a first magnitude representing a voltage at the terminals of the power relay for each measurement period,
integrating a third function of the current samples over each measurement period, to obtain a second magnitude representative of the current flowing in the power relay for each measurement period, and
calculating a ratio between the first and second magnitudes, or between an average of the first magnitudes and an average of the second magnitudes, to obtain the resistance value of the power relay for the measurement period(s).

13. The monitoring method according to claim 11, wherein the first, second and third functions respectively comprise a multiplication of the samples of upstream voltage, downstream voltage and current by a gain of upstream voltage, downstream voltage and current, respectively.

14. The monitoring method according to claim 10, wherein the average of the first magnitudes and the average of the second magnitudes are obtained by applying selective digital filtering of rectangular impulse response and sin(x)/x frequency response.

15. The monitoring method according to claim 11, wherein the first, second, and third function respectively comprise a Butterworth filtering of said samples, at least of the third order, and presenting a cutoff frequency 3 to 25 times greater than that of the signal.

16. The monitoring method according to claim 10, wherein when the measurement times of the samples are synchronized with the electrical signal, the integrations are replaced by selections of a maximum value taken over the measurement period.

17. The monitoring method according to claim 10, comprising disregarding samples with an amplitude that makes them prone to noise.

18. A non-transitory computer-readable storage medium comprising instructions which when executed by a processor cause the implementation of a method according to claim 10.
